(19) United States
(12) Patent Application Publication
(10) Pub. No.: US 2019/0205472 A1
(43) Pub. Date: Jul. 4, 2019

(54) Ranking Entity Based Search Results Based on Implicit User Interactions

(71) Applicant: salesforce.com, inc., San Francisco, CA (US)

(72) Inventor: Swapnil Sanjay Kulkarni, San Francisco, CA (US)

(21) Appl. No.: 15/857,613

(22) Filed: Dec. 28, 2017

(51) Int. Cl. G06F 17/30; H04L 29/08

(52) U.S. Cl. CPC G06F 17/30867; G06F 3/0482; H04L 67/22

(57) ABSTRACT

A system stores objects of different types and allows search across the objects. The system receives search requests and processes them to determine search results matching the search criteria. For each of a plurality of search requests the system tracks implicit user interactions and stores information of implicit user interactions and associated search results and search requests. For each of a plurality of search results a relevance score is determined based on the stored information. The relevance score of each entity type is used to rank search results for search requests.

### BACKGROUND

### Field of Art

The disclosure relates in general to ranking search results and in particular to ranking entity based search results using implicit user interactions monitored using a search engine results page or other user interfaces used by a user, for example, to access information.

### Description of the Related Art

Online systems used by enterprises, organizations, and businesses store large amounts of information. These systems allow users to perform searches for information. An online system deploys a search engine that scores documents using different signals, and returns a list of results ranked in order of relevance. The relevance may depend upon a number of factors, for example, how well the search query matches the document, the document's freshness, the document's reputation, and the user's interaction feedback on the results. A result click provides a clear intent that the user was interested in the search result. Therefore, the result click usually serves as a primary signal for improving the search relevance. However, there are several known limitations of the result click data.

Search engine results page often presents a result in the form of a summary that typically includes a title of the document, a hyperlink, and a contextual snippet with highlighted keywords.

Contextual snippet usually includes an excerpt of the matched data, allowing user to understand why and how a result was matched to the search query. Often this snippet includes additional relevant information about the result, thereby saving the user a click or a follow up search. For example, a user may search for an account and the result summary may present additional details about the given account such as contact information, mailing address, active sales pipeline, and so on. If the user was simply interested in the contact information for the searched account, the summary content satisfies the user's information need. Accordingly, the user may never perform a result click.

Similarly, searches on unstructured data, particularly text data like knowledge articles or feed results tend to produce fewer or no clicks. For these, the user may simply read and successfully consume search results without generating any explicit interaction data. Improved search result summaries and unstructured data searches typically tend to reduce the search click data volume, thereby inversely affecting user feedback data collected by the online system that is used for search relevance.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1A shows an overall system environment illustrating an online system receiving search requests from clients and processing them, in accordance with an embodiment.

FIG. 1B show an overall system environment illustrating an online system receiving search requests from clients and processing them, in accordance with an embodiment.

FIG. 2A shows the system architecture of a search module, in accordance with an embodiment.

FIG. 2B shows the system architecture of a search service module, in accordance with an embodiment.

FIG. 3A shows the system architecture of a client application, in accordance with an embodiment.

FIG. 3B shows the system architecture of a client application, in accordance with an embodiment.

FIG. 4 shows a screen shot of a user interface for monitoring implicit user interactions with search results, in accordance with an embodiment.

FIG. 5 shows the process of collecting implicit user interaction data for determining entity type relevance scores, in accordance with an embodiment.

FIG. 6 shows the process of ranking search results based on entity type relevance scores, in accordance with an embodiment.

FIG. 7 shows a high-level block diagram of a computer for processing the methods described herein.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### DETAILED DESCRIPTION

### System Overview

An online system receives a search request that invokes the search engine to deliver most relevant search results for the given query. The online system returns the search results to the client application which then constructs and presents a search results page to the user. The user interacts with the search results page. User interaction data is captured by the client application and is sent back to the online system to improve search relevance for subsequent searches. Historical search queries and user's interactions with their search results are a strong signal for search relevance. The search engine can re-rank search results and re-compute document reputations from these user interactions.

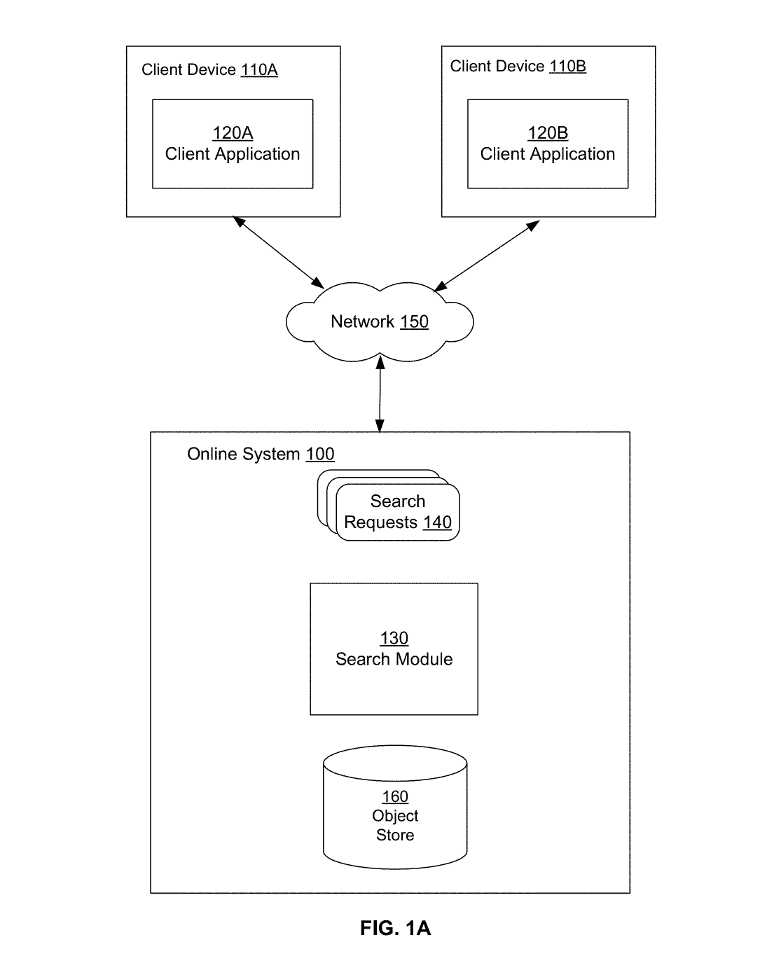

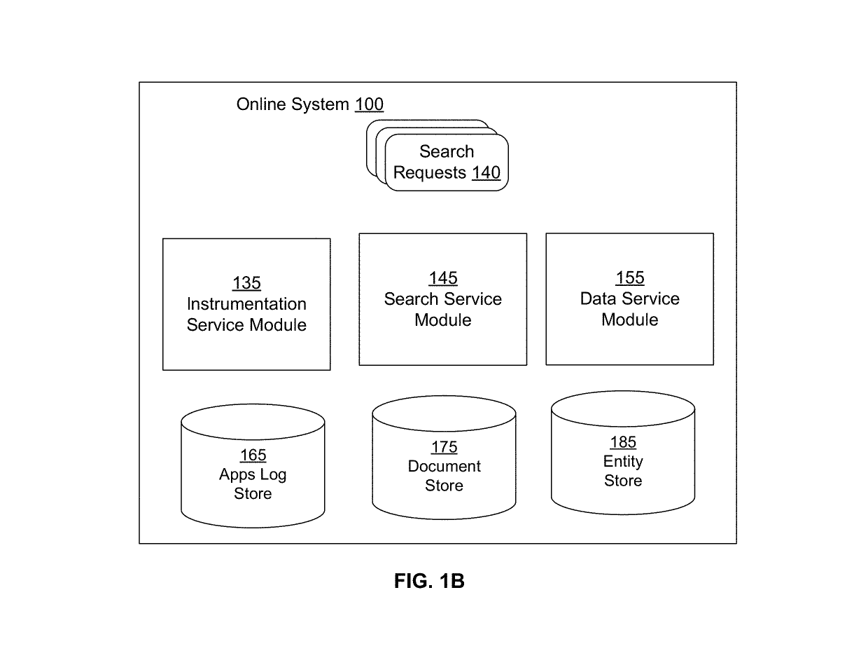

FIG. 1A show an overall system environment illustrating an online system receiving search requests from clients and processing them, in accordance with an embodiment. As shown in FIG. 1A, the overall system environment includes an online system 100, one or more client devices 110, and a network 150. Other embodiments may use more or fewer or different systems than those illustrated in FIG. 1A. Functions of various modules and systems described herein can be implemented by other modules and/or systems than those described herein.

FIG. 1A and the other figures use like reference numerals to identify like elements. A letter after a reference numeral, such as “120A,” indicates that the text refers specifically to the element having that particular reference numeral. A reference numeral in the text without a following letter, such as “120,” refers to any or all of the elements in the figures bearing that reference numeral (e.g. “120” in the text refers to reference numerals “120A” and/or “120B” in the figures).

A client device 110 is used by users to interact with the online system 100. A user interacts with the online system 100 using client device 110 executing client application 120. An example of a client application 120 is a browser application. In an embodiment, the client application 120 interacts with the online system 100 using HTTP requests sent over network 150.

The online system 100 includes an object store 160 and a search module 130. The online system 100 receives search requests 140 from users via the client devices 110. The object store 160 stores data represented as objects. An object may represent a document, for example, a knowledge article, an FAQ (frequently asked question) document, a manual for a product, and so on. An object may also represent an entity associated with an enterprise, for example, an entity of entity type opportunity, case, account, and so on. In general, search results comprise object that may be documents or entities. Accordingly, search results for a search query may include documents, entities, or a combination of both. A search request 140 specifies search criteria, for example, a search query comprising search terms/keywords, logical operators specifying relations between the search terms, details about facets to retrieve, additional filters like size, scope, ordering, and so on. The search module 130 processes the search requests 140 and determines search results comprising documents/entities that match the search criteria specified in the search request 140. The search module 130 ranks the search results based on a measure of likelihood that the user is interested in each search result. The search module 130 sends the ranked search results to the client device 110. The client device 110 presents the search results based on the ranking, for example, in descending order with higher ranked search results occupying a higher position in the order.

The search module 130 uses features extracted from search results to rank the search results. In an embodiment, the search module 130 determines a relevance score for each search result based on a weighted aggregate of the features describing the search result. Each feature is weighted based on a feature weight associated with the feature. The search module 130 adjusts the feature weights to improve the ranking of search results.

In an embodiment, the search module 130 modifies the feature weights and measures the impact of the modification by applying the new feature weights to past search requests and analyzing the newly ranked results. The online system stores information describing past search requests. The stored information comprises, for each stored search request, the search request and the set of search results returned in response to the search request. The online system 100 monitors which results were of interest to the user based on user interactions responsive to the user being presented with the search results. Accordingly, if the online system receives a data access request for a given search result, the online system 100 marks the given search result as an accessed search result.

The search module 130 adjusts the feature weights to measure if the ranks of the accessed search results improve. Accordingly, the search module 130 may try a plurality of different feature weight combinations to find a particular feature weight combination that results in the optimal ranking of accessed search results. The search module 130 determines that a ranking based on a first set of feature weights is better than a ranking based on a second set of feature weights if the accessed results are ranked higher on average based on the first set of feature weights compared to the second set of feature weights.

In some embodiments, an online system 100 stores information of one or more tenants to form a multi-tenant system. Each tenant may be an enterprise as described herein. As an example, one tenant might be a company that employs a sales team where each salesperson uses a client device 110 to manage their sales process. Thus, a user might maintain contact data, leads data, customer follow-up data, performance data, goals, and progress data, etc., all applicable to that user's personal sales process.

In one embodiment, online system 100 implements a web-based customer relationship management (CRM) system. For example, in one embodiment, the online system 100 includes application servers configured to implement and execute CRM software applications as well as provide related data, code, forms, webpages and other information to and from client devices 110 and to store to, and retrieve from, a database system related data.

With a multi-tenant system, data for multiple tenants may be stored in the same physical database, however, tenant data typically is arranged so that data of one tenant is kept logically separate from that of other tenants so that one tenant does not have access to another tenant's data, unless such data is expressly shared. In certain embodiments, the online system 100 implements applications other than, or in addition to, a CRM application. For example, the online system 100 may provide tenant access to multiple hosted (standard and custom) applications, including a CRM application. According to one embodiment, the online system 100 is configured to provide webpages, forms, applications, data and media content to client devices 110. The online system 100 provides security mechanisms to keep each tenant's data separate unless the data is shared.

A multi-tenant system may implement security protocols and access controls that keep data, applications, and application use separate for different tenants. In addition to user-specific data and tenant-specific data, the online system 100 may maintain system level data usable by multiple tenants or other data. Such system level data may include industry reports, news, postings, and the like that are sharable among tenants.

It is transparent to customers that their data may be stored in a database that is shared with other customers. A database table may store rows for a plurality of customers. Accordingly, in a multi-tenant system, various elements of hardware and software of the system may be shared by one or more customers. For example, the online system 100 may execute an application server that simultaneously processes requests for a number of customers.

In an embodiment, the online system 100 optimizes the set of features weights for each tenant of a multi-tenant system. This is because each tenant may have a different usage pattern for the search results. Accordingly, search results that are relevant for a first tenant may not be very relevant for a second tenant. Therefore, the online system determines a first set of feature weights for the first tenant and a second set of feature weights for the second tenant.

The online system 100 and client devices 110 shown in FIG. 1A can be executed using computing devices. A computing device can be a conventional computer system executing, for example, a Microsoft™ Windows™-compatible operating system (OS), Apple™ OS X, and/or a Linux distribution. A computing device can also be a client device having computer functionality, such as a personal digital assistant (PDA), mobile telephone, etc. The online system 100 stores the software modules storing instructions, for example search module 130.

The interactions between the client devices 110 and the online system 100 are typically performed via a network 150, for example, via the Internet. In one embodiment, the network uses standard communications technologies and/or protocols. In another embodiment, various devices, and systems can use custom and/or dedicated data communications technologies instead of, or in addition to, the ones described above. The techniques disclosed herein can be used with any type of communication technology, so long as the communication technology supports receiving by the online system 100 of requests from a sender, for example, a client device 110 and transmitting of results obtained by processing the request to the sender.

FIG. 1B show an overall system environment illustrating an online system receiving search requests from clients and processing them, in accordance with another embodiment. As shown in FIG. 1B, the online system includes an instrumentation service module 135, a search service module 145, a data service module 155, an apps log store 165, a document store 175, and an entity store 185. The functionality of modules shown in FIG. 1B may overlap with the functionality of modules shown in FIG. 1A.

The online system 100 receives search requests 140 having different search criteria from clients. The search service module 145 executes searches and returns the most relevant results matching search criteria received in the search query.

The instrumentation service module 135 is a logging and monitoring module that receives logging events from different clients. The instrumentation service module 135 validates these events against pre-defined schemas. The instrumentation service module 135 may also enrich events with additional metadata like user id, session id, etc. Finally, the instrumentation service module 135 publishes these events as log lines to the app logs store 165.

The data service module 155 handles operations such as document and entity create, view, save and delete. It may also provide advanced features such as caching and offline support.

The apps log store 165 stores various types of application logs. Application logs may include logs for both clients as well different modules of the online system itself.

The entity store 185 stores details of entities supported by an enterprise. Entities may represent an individual account, which is an organization or person involved with a particular business (such as customers, competitors, and partners). It may represent a contact, which represents information describing an individual associated with an account. It may represent a customer case that tracks a customer issue or problem, a document, a calendar event, and so on.

Each entity has a well-defined schema describing its fields. For example, an account may have an id, name, number, industry type, billing address etc. A contact may have an id, first name, last name, phone, email etc. A case may have a number, account id, status (open, in-progress, closed) etc. Entities might be associated with each other. For example, a contact may have a reference to account id. A case might include references to account id as well as contact id.

The document store 175 stores one or more documents of supported entity types. It could be implemented as a traditional relational database or NoSQL database that can store both structured and unstructured documents.

### System Architecture

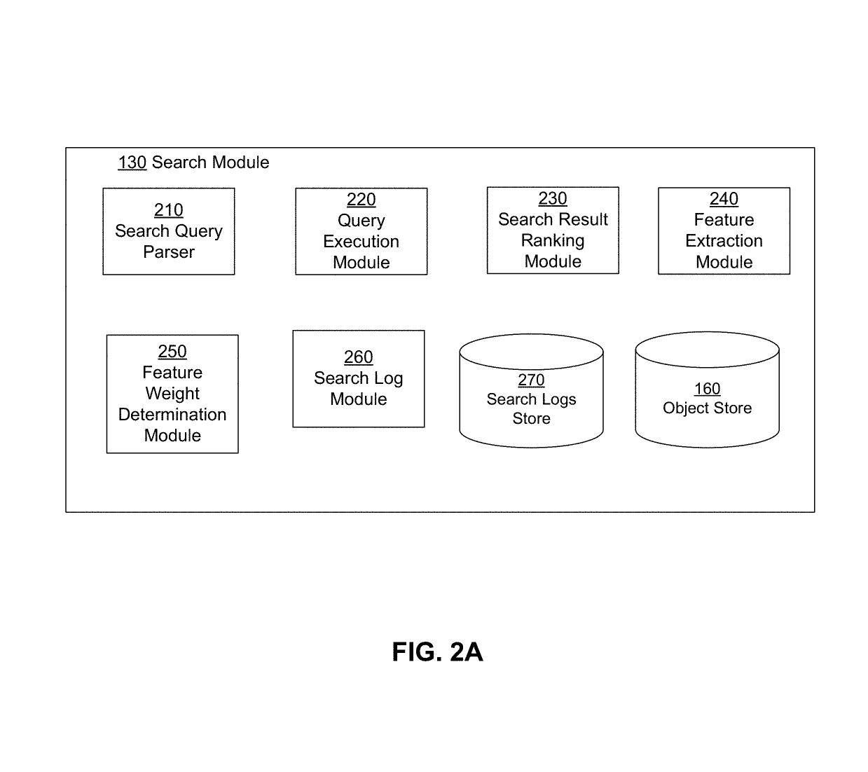

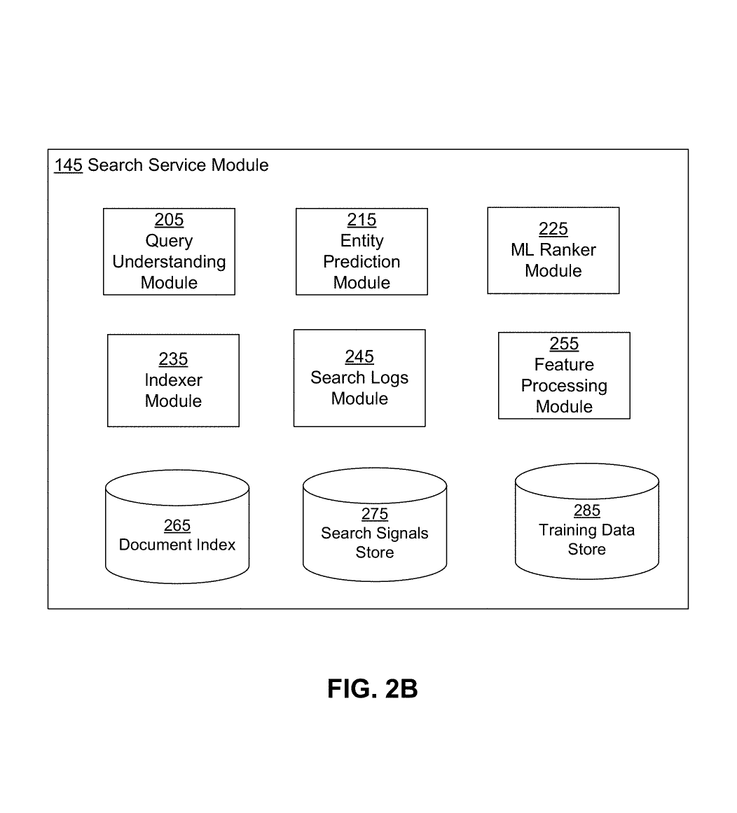

FIG. 2A shows the system architecture of a search module, in accordance with an embodiment. The search module 130 comprises a search query parser 210, a query execution module 220, a search result ranking module 230, a search log module 260, a feature extraction module 240, a feature weight determination module 250, and a search logs store 270, and may comprise the object store 160. Other embodiments may include more or fewer modules. Functionality indicated herein as being performed by a particular module may be performed by other modules.

The object store 160 stores entities associated with an enterprise. The object store 160 may also store documents, for example, knowledge articles, FAQs, manuals, and so on. An enterprise may be an organization, a business, a company, a club, or a social group. An entity may have an entity type, for example, account, a contact, a lead, an opportunity, and so on. The term “entity” may also be used interchangeably herein with “object”.

An entity may represent an account representing a business partner or potential business partner (e.g. a client, vendor, distributor, etc.) of a user, and may include attributes describing a company, subsidiaries, or contacts at the company. As another example, an entity may represent a project that a user is working on, such as an opportunity (e.g. a possible sale) with an existing partner, or a project that the user is trying to get. An entity may represent an account representing a user or another entity associated with the enterprise. For example, an account may represent a customer of the first enterprise. An entity may represent a user of the online system.

In an embodiment, the object store 160 stores an object as one or more records. An object has data fields that are defined by the structure of the object (e.g. fields of certain data types and purposes). For example, an object representing an entity may store information describing the potential customer, a status of the opportunity indicating a stage of interaction with the customer, and so on. An object representing an entity of entity type case may include attributes such as a date of interaction, information identifying the user initiating the interaction, description of the interaction, and status of the interaction indicating whether the case is newly opened, resolved, or in progress.

The object store 160 may be implemented as a relational database storing one or more tables. Each table contains one or more data categories logically arranged as columns or fields. Each row or record of a table contains an instance of data for each category defined by the fields. For example, an object store 160 may include a table that describes a customer with fields for basic contact information such as name, address, phone number, fax number, etc. Another table might describe a purchase order, including fields for information such as customer, product, sale price, date, etc.

The search query parser 210 parses various components of a search query. The search query parser 210 checks if the search query conforms to a predefined syntax. The search query parser builds a data structure representing information specified in the search query. For example, the search query parser 210 may build a parse tree structure based on the syntax of the search query. The data structure provides access to various components of the search query to other modules of the online system 100.

The query execution module 220 executes the search query to determine the search results based on the search query. The search results determined represent the objects stored in the object store 160 that satisfy the search criteria specified in the search query. In some embodiments, the query execution module 220 develops a query plan for executing a search query. The query execution module 220 executes the query plan to determine the search results that satisfy the search criteria specified in the search query. As an example, a search query may request all entities of a particular entity type that include certain search terms, for example, all entities representing cases that contain certain search terms. The query execution module 220 identifies entities of the specified entity type that include the search terms as specified in the search criteria of the search query. The query execution module 220 provides a set of identified entities, to the feature extraction module 240.

The feature extraction module 240 extracts features of the entities from the identified set of entities and provides the extracted features to the feature weight determination module 250. In an embodiment, the feature extraction module 240 represents a feature using a name and a value. The features describing the entities may depend on the entity type. Some features may be independent of the entity type and apply to all entity types. Examples of features extracted by the feature extraction module 240 include a time of the last modification of an entity or the age of the last modification of the entity determined based of the length of time interval between the present time and the last time of modification.

The feature extraction module 240 extracts entity type specific features from certain entities. For example, if an entity represents an opportunity or a potential transaction, the feature extraction module 240 extracts a feature indicating whether an entity representing an opportunity is closed or a feature indicating an estimate of time when the opportunity is expected to close. As another example, if an entity represents a case, feature extraction module 240 extracts features describing the status of the case, status of the case indicating whether the case is a closed case, an open case, an escalated case, and so on.

The feature weight determination module 250 determines weights for features and assigns scores for features of search results by the query execution module 220. Different features have different contribution to the overall measure of relevance of the search result. The differences in relevance among features of a search result with regards to a search request 140 are represented as weights. Each feature of each determined search result is scored according to its relevance to search criteria of the search request, then those scores are weighted and combined to create a relevance score for each search result.

For example, if a search result has two features, if the first feature historically correlates highly with relevance, and the second feature does not, then the first feature will have a higher weight than the second feature. Hence, if the first search result scores highly for the first feature and low for the second feature, it will have a high relevance score once the first feature's score is weighted by the high weighting, despite the low scoring of the second feature for that search result. However, if a second search result scores poorly on the first feature but highly on the second, it will have a low relevance score due to the low weighting of the first feature. Although in each case one feature matched, the greater association of one with search result relevance causes disparity between relevance scores depending upon which feature matches a search criteria.

Feature weights may be determined by analysis of search result performance and training models. This can be done using machine learning. Dimensionality reduction (e.g., via linear discriminant analysis, principle component analysis, etc.) may be used to reduce Machine learning algorithms used include support vector machines (SVMs), boosting for other algorithms (e.g., AdaBoost), neural net, logistic regression, naive Bayes, memory-based learning, random forests, bagged trees, decision trees, boosted trees, boosted stumps, etc.

Random forest classification based on predictions from a set of decision trees may be used to train a model. Each decision tree splits the source set into subsets based on an attribute value test. This process is repeated in a recursive fashion. A decision tree represents a flow chart, where each internal node represents a test on an attribute. For example, if the value of an attribute is less than or equal to a threshold value, the control flow transfers to a first branch and if the value of the attribute is greater than the threshold value, the control flow transfers to a second branch. Each branch represents the outcome of a test. Each leaf node represents a class label, i.e., a result of a classification.

Each decision tree uses a subset of the total predictor variables to vote for the most likely class for each observation. The final random forest score is based on the fraction of models voting for each class. A model may perform a class prediction by comparing the random forest score with a threshold value. In some embodiments, the random forest output is calibrated to reflect the probability associated with each class.

The weights of features for predicting relevance of different search requests with different sets of search criteria and features may be different. Accordingly, a different machine learning model may be trained for each search request or cluster of similar search requests and applied to search queries with the same set of dimensions. Alternatively, instead of machine learning, depending upon embodiment, the system may use other techniques to adjust the weights of various features per object per search request, depending upon user interaction with those features. For example, if a search result is interacted with multiple times in response to various similar search requests, those interactions may be recorded and the search result may thereafter be given a much higher relevance score, or distinguishing features of that search result may be weighted much greater for future similar search requests. In an embodiment, the information identifying the search result that was accessed by the user is provided as a labeled training dataset for training the machine learning model configured to determine weights of features used for determining relevance scores.

A factor which impacts the weight of a feature vector, or a relevance score overall, is user interaction with the corresponding search result. If a user selects one or more search results for further interaction, those search results are deemed relevant to the search request, and therefore the system records those interactions and uses those stored records to improve search result ranking for the subsequent search requests. An example of a user interaction with a search result is selecting the search result by placing the cursor on a portion of the user interface displaying the search result and clicking on the search result to request more data describing the search result. This is an explicit user interaction performed by the user via the user interface. However, not all user interactions are explicit. Embodiments of the invention identify implicit interactions, such as the user placing the cursor on the portion of the user interface displaying the search result while reading the search summary presented with the search result without explicitly clicking on the search result. Such implicit interactions also indicate the relevance of the search result. Hence, the online system considers implicit user interactions when ranking search results by tracking them, such as by a pointer device listener 310.

The search result ranking module 230 ranks search results determined by the query execution module 220 for a given search query. For example, the online system may perform this by applying a stored ranking model to the features of each search result and thereafter sorting the search results in descending order of relevance score. Factors such as search result interaction, explicit and implicit, also impact the ranking of each search result. Search results which have been interacted with for a given search request are ranked higher than other search results for similar search requests. In one embodiment, search results which have been explicitly interacted with are ranked higher than search results which have been implicitly interacted with since an explicit interaction can be determined with a higher certainty than an implicit user interaction.

In one embodiment, the similarity of search requests is determined by analysis of search requests, which are thereby grouped in the search logs store 270 by the search log module 260. In an embodiment, the online system clusters search requests into clusters of similar search requests, using a machine learning based classifier. If search requests are clustered in a store, any search request of a given cluster is similar to the other search requests within its cluster. If search requests are clustered, the online system adjusts the importance of various features, and therefore corresponding weights, for the entirety of the cluster. In an embodiment, the online system clusters search requests based on a matching of the search results. For example, search requests that return similar search results are matched together. In an embodiment, the online system determines a matching score for two search requests based on an amount of overlap of search results returned by the two search queries. For example, two search queries that return search results that have 80% overlap are determined to have a higher match score than two search queries that return search results that have 30% overlap.

In one embodiment, entity type is one of the features used for determining relevance of search results for ranking them. For a cluster of similar search requests, the online system determines, for each entity type that may be returned as a search result, a weight based on an aggregate number of implicit and/or explicit user interactions with search results of that entity type. Accordingly, the online system weighs search results of certain entity types as more relevant than search results of other entity types for that cluster of search queries. Accordingly, when the online system receives a search request, the online system ranks the search results with entity types rated more relevant for that cluster of search requests higher than search results with entity types rated less relevant for that cluster of search requests.

The search log module 260 stores information describing search requests, also known as search queries, processed by the online system 100 in search logs store 270. The search log module 260 stores the search query received by the online system 100 as well as information describing the search results identified in response to the search query. The search log module 260 also stores information identifying accessed search results. An accessed search result represents a search result for which the online system receives a request for additional information responsive to providing the search results to a requestor. For example, the search results may be presented to the user via the client device 120 such that each search result displays a link providing access to the entity represented by the search result. Accordingly, a result is an accessed result if the user clicks on the link presented with the result. An accessed result may also be a result the user has implicitly interacted with.

In an embodiment, the search logs store 270 stores the information in a file, for example, as a tuple comprising values separated by a separator token such as a comma. In another embodiment, the search logs store 270 is a relational database that stores information describing searches as tables or relations.

FIG. 2B shows the system architecture of a search service module 145, in accordance with an embodiment. The search service module 145 includes a query understanding module 205, an entity prediction module 215, a machine learning (ML) ranker module 225, an indexer module 235, a search logs module 245, a feature processing module 255, a document index 265, a search signals store 275, and a training data store 285. Other embodiments may include other modules in the search service module 145.

The query understanding module 205 determines what the user is searching for, i.e., the precise intent of the search query. It corrects an ill-formed query. It refines query by applying techniques like spell correction, reformulation and expansion. Reformulation includes application of alternative words or phrases to the query. Expansion includes sending more synonyms of the words. It may also send morphological words by stemming.

Furthermore, the query understanding module 205 performs query classification and semantic tagging. Query classification represents classifying a given query in a predefined intent class (also referred to herein as a cluster of similar queries.). For example, the query understanding module 205 may classify “curry warriors san francisco” as a sports related query.

Semantic tagging represents identifying the semantic concepts of a word or phrase. The query understanding module 205 may determine that in the example query, “curry” represents a person's name, “warriors” represents a sports team name, and “san francisco” represents a location.

The entity prediction module 215 predicts which entities the user is most likely searching for given search query. In some embodiments, the entity prediction module 215 may be merged into query understanding module.

Entity prediction is based on machine learning (ML) algorithm which computes probability score for each entity for given query. This ML algorithm generates a model which may have a set of features. This model is trained offline using training data stored in training data store 285.

The features used by the ML model can be broadly divided into following categories: (1) Query level features or search query features: These features depend only on the query. While training, the entity prediction module 215 builds an association matrix of queries to identify similar set of queries. It extracts click and hover information from these historical queries. This information serves as a primary distinguishing feature.

The ML ranker module 225 is a machine-learned ranker module. Learning to rank or machine-learned ranking (MLR) is the application of machine learning in the construction of ranking models for information retrieval systems.

There are several standard retrieval models such as TF/IDF and BM25 that are fast enough to be produce reasonable results. However, these methods can only make use of very limited number of features. In contrast, MLR system can incorporate hundreds of arbitrarily defined features.

Users expect a search query to complete in a short time (such as a few hundred milliseconds), which makes it impossible to evaluate a complex ranking model on each document in a large corpus, and so a multi-phase scheme can be used.

Level-1 Ranker: top-K retrieval first, a small number of potentially relevant documents are identified using simpler retrieval models which permit fast query evaluation, such as the vector space model (TF/IDF) and BM25, or a simple linear ML model. This ranker is completely at individual document level, i.e. given a (query, document) pair, assign a relevance score.

Level-2 Ranker: In the second phase, a more accurate but computationally expensive machine-learned model is used to re-rank these documents. This is where heavy-weight ML ranking takes place. This ranker takes into consideration query classification and entity prediction external features from query understanding module and entity prediction module respectively.

The level-2 ranker may be computationally expensive due to various factors like it may depend upon certain features that are computed dynamically (between user, query, documents) or it may depend upon additional features from external system. Typically, this ranker operates on a large number of features, such that collecting/sending those features to the ranker would take time. ML Ranker is trained offline using training data. It can also be further trained and tuned with live system using online A/B testing.

The training data store 285 stores training data that typically consists of queries and lists of results. Training data may be derived from search signals store 275. Training data is used by a learning algorithm to produce a ranking model which computes relevance of results for actual queries.

The feature processing module 255 extracts features from various sources of data including user information, query related information, and so on. For ML algorithms, query-document pairs are usually represented by numerical vectors, which are called feature vectors. Components of such vectors are called features or ranking signals.

Features can be broadly divided into following categories:

(1) Query-independent or static features: These features depend only on the result document, not on the query. Such features can be precomputed in offline mode during indexing. For example, document lengths and IDF sums of document's fields, document's static quality score (or static rank), i.e. document's PageRank, page views and their variants and so on.

(2) Query-dependent or dynamic features: These features depend both on the contents of the document, the query, and the user context. For example, TF/IDF scores and BM25 score of document's fields (title, body, anchor text, URL) for a given query, connection between the user and results, and so on.

(3) Query level features or search query features: These features depend only on the query. For example, the number of words in a query, or how many times this query has been run in the last month and so on.

The feature processing module 255 includes a learning algorithm that accurately selects and stores subset of very useful features from the training data. This learning algorithm includes an objective function which measures importance of collection of features. This objective function can be optimized (maximization or minimization) depending upon the type of function. Optimization to this function is usually done by humans.

The feature processing module 255 excludes highly correlated or duplicate features. It removes irrelevant and/or redundant features that may produce discriminating outcome. Overall this module speeds up learning process of ML algorithms.

The search logs module 245 processes raw application logs from the app logs store by cleaning, joining and/or merging different log lines. These logs may include: (1) Result click logs—The document id, and the result's rank etc. (2) Query logs—The query id, the query type and other miscellaneous info. This module produces a complete snapshot of the user's search activity by joining different log lines. After processing, each search activity is stored as a tuple comprising values separated by a token such as comma. The data produced by this module can be used directly by the data scientists or machine learning pipelines for training purposes.

The search signals store 275 stores various types of signals that can be used for data analysis and training models. The indexer module 235 collects, parses, and stores document indexes to facilitate fast and accurate information retrieval.

The document index 265 stores the document index that helps optimize speed and performance in finding relevant documents for a search query. Without an index, the search engine would scan every document in the corpus, which would require considerable time and computing power. For example, while an index of 10,000 documents can be queried within milliseconds, a sequential scan of every word in 10,000 large documents could take hours.

The document index 265 may be an inverted index that helps evaluation of a search query by quickly locating documents containing the words in a query and then ranking these documents by relevance. Because the inverted index stores a list of the documents containing each word, the search engine can use direct access to find the documents associated with each word in the query in order to retrieve the matching documents quickly.

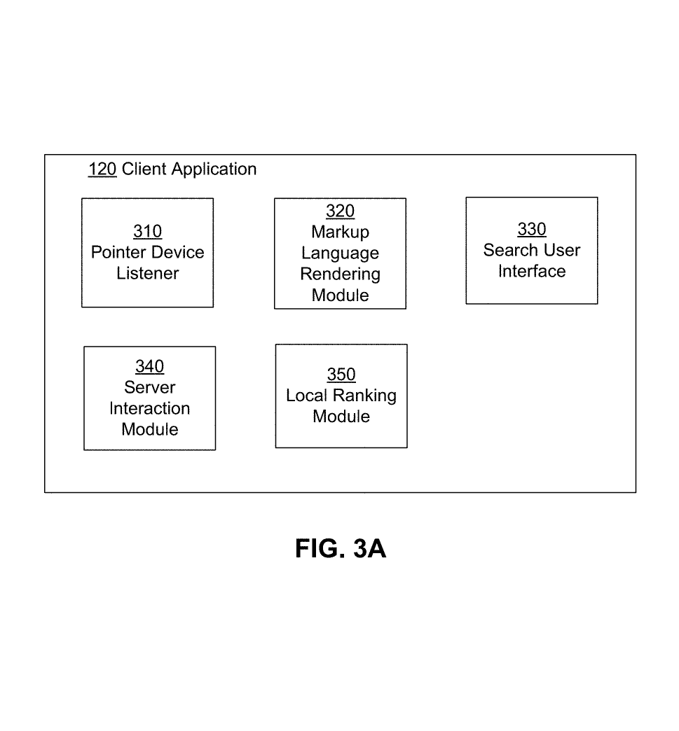

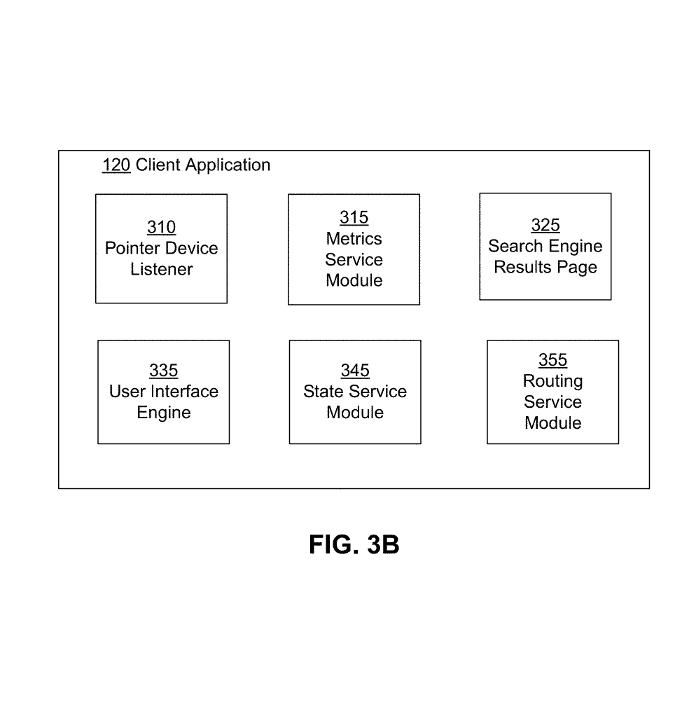

FIG. 3A shows the system architecture of a client application, in accordance with an embodiment. The client application 120 comprises the pointer device listener 310, a markup language rendering module 320, a search user interface 330, a server interaction module 340, and a local ranking module 350.

Data travels between the client application 120 and the online system 100 over the network 150. This is facilitated on the client application 120 side by the server interaction module 340. The server interaction module 340 connects the client application 120 to the network and establishes a connection with the online system 100. This may be done using file transfer protocol, for example, or any other computer network technology standard, or custom software and/or hardware, or any combination thereof.

The search user interface 330 allows the user to interact with the client application 120 to perform search functions. The search user interface 330 may comprise physical and/or on-screen buttons, which the user may interact with to perform various functions with the client application 120. For example, the search user interface 330 may comprise a query field wherein the user may enter a search query, as well as a results field wherein search results are displayed. In an embodiment, users may interact with search results by selecting them with a cursor.

The markup language rendering module 320 works with the server interaction module 340 and the search user interface 330 to present information to the user. The markup language rendering module 320 processes data from the server interaction module 340 and converts it into a form usable by the search user interface 330. In one embodiment, the markup language rendering module 320 works with the browser of the client application 120 to support display and functionality of the search user interface 330.

The pointer device listener 310 monitors and records user interactions with the client application 120. For example, the pointer device listener 310 tracks implicit interactions, such as search results over which the cursor hovers for a certain period of time. For example, each search result occupies an area of the search user interface 330, and the pointer device listener 310 logs a search result every time the cursor stays within search result's area of the search user interface 330 for more than a threshold amount of time. Those logged implicit interactions may be communicated to the online system 100 via the network 150 by the client application 120 using the server interaction module 340. Alternatively or additionally, the implicit and explicit user interactions are stored in the object store 160.

Depending upon the embodiment, the pointer device listener 310 records other types of interactions, explicit and/or implicit, in addition to or alternatively to those detailed supra. One type of user interaction recorded by the pointer device listener 310 is a user copying a search result, for example, for pasting it in another portion of the same user interface or a user interface of another application. The user interface of the client device may allow the user to select a region of the user interface without sending an explicit request to the online system. For example, if search results comprise a phone number, the pointer device listener 310 could log which search result had its phone number copied. Another type of user interaction recorded by the pointer device listener 310 is a user screenshotting one or more search results. If a user uses a feature of the client application 120 or other functionality of the client device 110, such as a screenshot application, to screenshot one or more search results, the pointer device listener 310 could log which search results were captured by the screenshot. The interactions logged by the pointer device listener 310 may be used to adjust search result rankings, as detailed supra, done by the local ranking module 350 and/or the search result ranking module 230.

FIG. 3B shows the system architecture of a client application, in accordance with an embodiment. As shown in FIG. 3B, the client application comprises the pointer device listener 310 (as described above in connection with FIG. 3A), a metrics service nodule 315, a search engine results page 325, a UI (user interface) engine 335, a state service module 345, and a routing service module 355. Other embodiments may include different modules than those indicated here.

Client applications are becoming increasingly complicated. The state service module 345 manages the state of the application. This state may include responses from server side services and cached data, as well as locally created data that has not been yet sent over the wire to the server. The state may also include active actions, state of current view, pagination and so on.

The metrics service nodule 315 provides APIs for instrumenting user interactions in a modular, holistic and scalable way. It may also offer ways to measure and instrument performance of page views. It collects logging events from various views within the client application. It may batch all these requests and send it over to instrumentation service module 135 for generating the persisted log lines in app log store 165.

The UI engine 335 efficiently updates and renders views for each state of the application. It may manage multiple views, event handling, error handling and static resources. It may also manage other aspects such as localization.

The routing service module 355 manages navigation within different views of the application. It contains a map of navigation routes and associated views. It usually tries to route application to different views without reloading of the entire application.

The search engine results page 325 is used by the user to conduct searches to satisfy information needs. User interacts with the interface by issuing a search query, then reviewing the results presented on the page to determine which or if any results may satisfy user's need. The results may include documents of one or more entity types. Results are typically grouped by entities and shown in the form of sections that are ordered based upon relevance.

User may move pointer device around the page, hovering over and possibly clicking on result hyperlinks. The page under the hood tracks pointer device to track explicit as well as implicit user interaction. Explicit user interaction such as click on hyperlink or copy-paste. On other hand, implicit interaction includes hovering over the results while user examines the results. These interactions are instrumented by dispatching events to the metrics service module 315.

The pointer device listener 310 monitors a cursor used for clicking results and hovering/scrolling on results page.

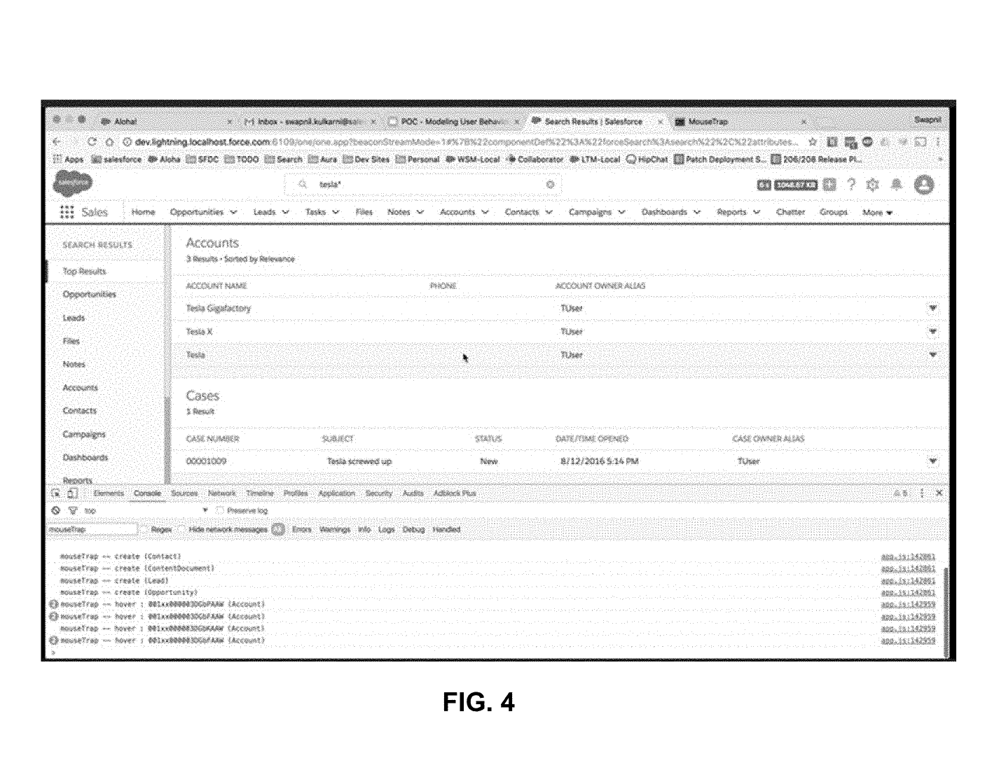

FIG. 4 shows a screen shot of a user interface that allows monitoring of implicit user interactions with search results, in accordance with an embodiment. In this embodiment the client application 120 comprises a browser. As seen in the figure, there are three account displayed as search results, each with its own area of the user interface, which are displayed in response to a search request which was entered by the user in a different region of the user interface. As shown in the figure, the cursor is hovering over the third result, which may be recorded as an implicit user interaction by the pointer listening device 310 if the cursor remains there for at least a set period of time. For example, the system may be configured such that a cursor remaining in an area of a search result for longer than five seconds is recorded as an implicit user interaction.

In this example, the pointer listening device 310 records the interactions, as seen in a console display region on the figure. In the console display region, there is a set of log entries, several of which comprise cursor location data and corresponding search results, for later use in search result ranking. As seen in the figure, in some embodiments, the pointer device listener 310 may record only a feature of search results implicitly interacted with by the user. In this example, that feature is entity type. When used for adjusting search result rankings, search results comprising that entity type will be given a greater relevance score for search queries similar to the search query of the figure. As seen in the figure, depending upon embodiment, the client application 120 may comprise more than a browser.

### System Processes

The processes associated with searches performed by online system 100 are described herein. The steps described herein for each process can be performed in an order different from those described herein. Furthermore, the steps may be performed by different modules than those described herein.

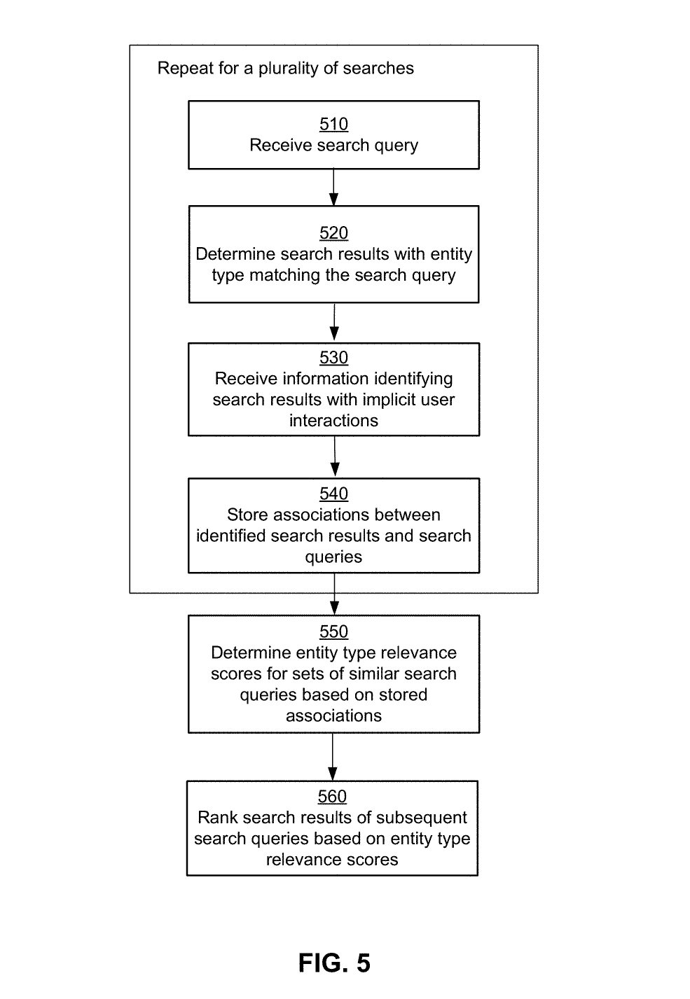

FIG. 5 shows the process of executing searches, in accordance with an embodiment. The online system 100 receives a search query and processes it. The search query may be received from a client application 120 executing on a client device 110 via the network 150. In some embodiments, the search query may be received from an external system, for example, another online system via a web service interface provided by the online system 100.

The online system 100 receives 510 a search query. The search query may be from a client application 120, received over the network 150. The search query comprises a set of search criteria, as detailed supra. The query execution module 220 determines 520 search results matching the search query. Entity type is a feature of each search result. The search results are determined from the object store 160. The online system 100 receives 530 information identifying a search result selected by the user from the set of search results presented to the user based on implicit user interactions. As detailed supra, the pointer device listener 310 tracks user interactions, including implicit user interactions, with search results. The client application 120 periodically interacts 540 with the online system 100 to provide information describing implicit user interactions tracked by the pointer device listener 310 and their associations with search results and search queries. The client application 120 sends information describing the implicit user interactions to the online system 100 and the online system 100 stores the information including the implicit user interactions, search results, search queries, and associations therein in the object store 160. These steps are repeated for a plurality of search queries.

An entity type relevance score is determined 550 for sets (or clusters) of similar search queries based on associations between stored implicit user interactions, search results, and search queries. The entity type relevance score for a set of similar search queries indicates a likelihood of a user interacting with an entity of that entity type from the search results returned. In an embodiment, the online system determines the entity type relevance score for an entity type as an aggregate of the number of explicit or implicit user interactions performed by users with entities of that entity type returned as search results over a plurality of search requests. The aggregate value may represent the percentage of explicit and/or implicit user interactions performed with entities of that particular entity type returned as search results as compared to the total number of user interactions performed by users aggregated over all entity types. In an embodiment, the aggregate value represents the percentage total amount of time spent by the cursor on search results of the entity type as compared to the amount of time spent by the cursor on search results of all entity types. Each search query from each cluster of similar search queries may produce search results of differing entity types. Depending upon the cluster that is the closest match to a search query, the online system determines that search results of certain entity types are more relevant than others, according to analysis of previous implicit user interactions with search results returned for search queries of that cluster. Hence, the online system implements a ranking scheme or model comprising weighting search results by entity type for each cluster of similar search queries. Search results are ranked 560 according to the ranking scheme or model, based at least in part on entity type relevance scores. For example, for a given cluster of similar search queries, if entities of entity type “Account” historically result in more implicit user interactions than entities of entity type “Case” for search queries from that cluster, then subsequent similar search queries rank search results comprising entity type “Account” higher than search results of entity type “Case.”

In an embodiment, the online system is a multi-tenant system and the entity type relevance scores are determined for each tenant separately.

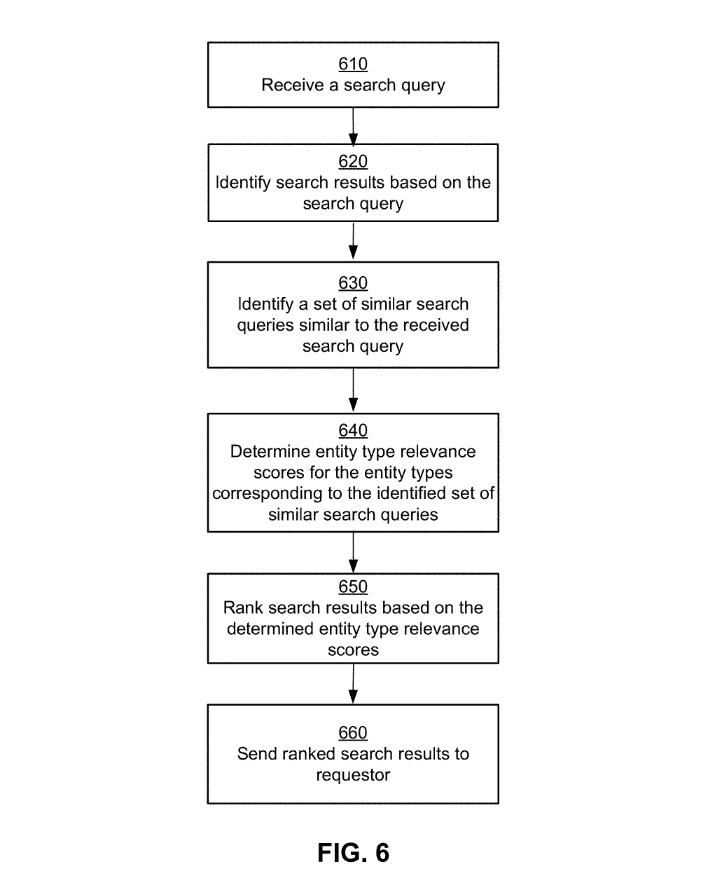

FIG. 6 shows the process of ranking search results based on entity type relevance scores, in accordance with an embodiment. The online system 100 receives a search query and processes it. The search query may be received from a client application 120 executing on a client device 110 via the network 150. In some embodiments, the search query may be received from an external system, for example, another online system via a web service interface provided by the online system 100.

The online system 100 receives 610 a search query. The search query may be from a client application 120, received over the network 150. The search query comprises a set of search criteria, as detailed supra. The query execution module 220 identifies 620 search results matching the search query. Entity type is one feature of a search result. The search results are identified from the object store 160.

The query execution module determines 630 the cluster to which the received search query belongs. Alternatively, the received search query is compared to logged search queries to determine a set of similar search queries, and the logged implicit user interactions and associated search results for each similar search query are analyzed to determine a weighting scheme or model for search results for the received search query based at least in part on entity type.

The search module 130 identifies the ranking scheme or model corresponding to the cluster of the search queries matching the incoming search query and applies it to the search results. The search module 130 determines 640 the entity type relevance score for each search result based on the entity type of the search result. The search module 130 may determine feature scores based on other features of the search results. The search result ranking module 230 determines a relevance score for each search result based on various feature scores including the entity type relevance score. The search module 130 ranks 650 the search results based on the relevance scores, for example in descending order by relevance score from greatest to least.

The search module 130 sends 660 the ranked search results to the requestor. If the online system 100 ranks the search results, the online system sends the ranked search results are over the network 150 to the client application 120, where the ranked search results are then sent for display.

Another embodiment of the search process is described as follows.

Client application issues a search request to the online system. The search service module 145 starts processing this request by first giving it to the query understanding module 205 which classifies the given query. The entity prediction module 215 generates a list of predicted entities and their priorities. The ML Ranker module 225 generates the most relevant results using query classification and entity prediction.

The online system returns search results along with entity ordering. Client application receives these results and renders them in the search engine results page 325. Results are arranged in sections as per their entity types. These sections are arranged in their respective priority order (most important entity section is placed on top).

Most users spend significant time examining the results before clicking, unless they find the most attractive result in front of their eyes. While examining, user interacts with the page by scrolling or moving cursor around the result summary. The search engine results page (SERP) 325 actively monitors the cursor movement on the page. SERP tracks the results that user attended along with their entity types.

User may end given search activity with one of the following outcomes: (1) Result found and user clicked result. (2) Result not found or result found but not clicked—At times the result summary fulfills the user's information needed hence click is unnecessary. Also for unstructured data searches like articles or feed searches. They involve results that are not actionable and user just have to consume them. After end of the search activity, SERP logs user interaction using metrics service module 315. For (1) log event would include click data as well as hover data. For (2) log event would include hover data only.

The instrumentation service module 135 in online system receives this log event which then further logs app log in the app logs store 165.

The search logs module 245 extracts app logs and generates search signals which are then stored in the search signals store 275.

The entity prediction module 215 learns the entity affinity for the given search to improve entity prediction for future searches.

In some embodiments, the online system collects implicit interaction feedback based on user interactions that are not limited to user interactions with search results. For example, the online system collects implicit interactions performed by users while browsing at records that may have been presented to user without a search request, for example, using a user interface for browsing through various types of entities. Accordingly, implicit user interaction data may be obtained from page views. The online system identifies the records/entity types on which user/user role spends more than a threshold time reading/creating/editing and use this information for ranking search results.

### Computer Architecture

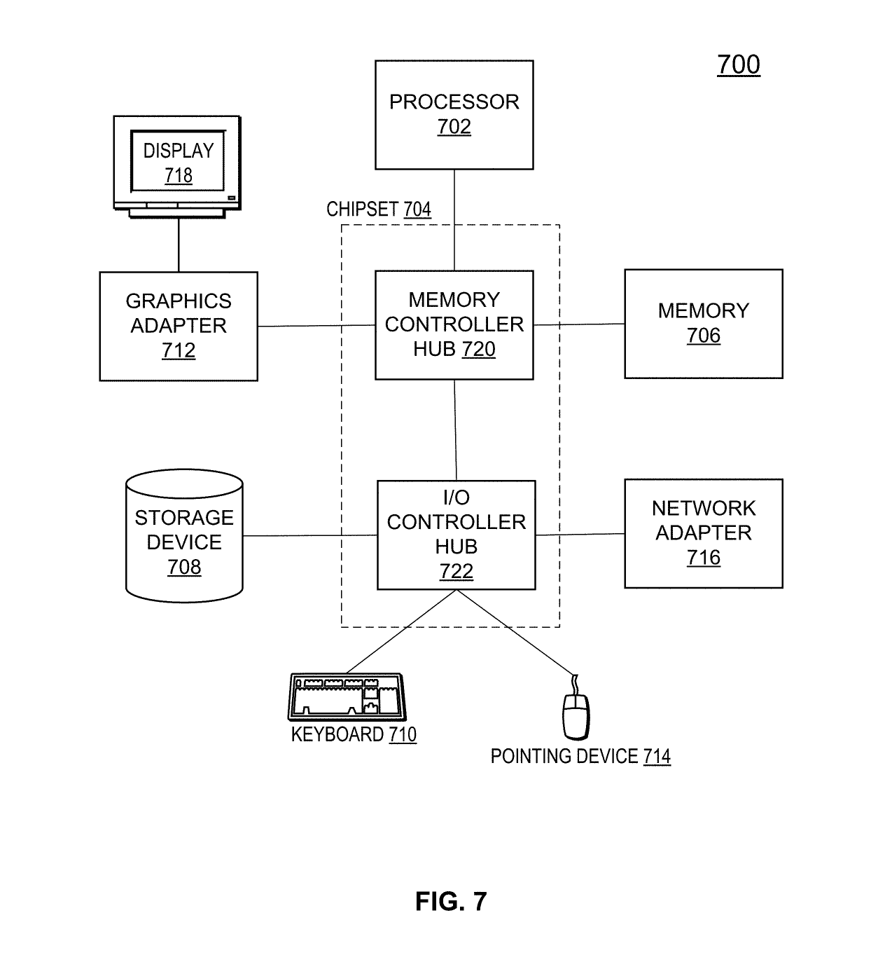

The entities shown in FIG. 1 are implemented using one or more computers. FIG. 7 is a high-level block diagram of a computer 700 for processing the methods described herein. Illustrated are at least one processor 702 coupled to a chipset 704. Also coupled to the chipset 704 are a memory 706, a storage device 708, a keyboard 710, a graphics adapter 712, a pointing device 714, and a network adapter 716. A display 718 is coupled to the graphics adapter 712. In one embodiment, the functionality of the chipset 704 is provided by a memory controller hub 720 and an I/O controller hub 722. In another embodiment, the memory 706 is coupled directly to the processor 702 instead of the chipset 704.

The storage device 708 is any non-transitory computer-readable storage medium, such as a hard drive, compact disk read-only memory (CD-ROM), DVD, or a solid-state memory device. The memory 706 holds instructions and data used by the processor 702. The pointing device 714 may be a mouse, track ball, or other type of pointing device, and is used in combination with the keyboard 710 to input data into the computer system 700. The graphics adapter 712 displays images and other information on the display 718. The network adapter 716 couples the computer system 700 to the network 150.

As is known in the art, a computer 700 can have different and/or other components than those shown in FIG. 7. In addition, the computer 700 can lack certain illustrated components. For example, the computer acting as the online system 100 can be formed of multiple blade servers linked together into one or more distributed systems and lack components such as keyboards and displays. Moreover, the storage device 708 can be local and/or remote from the computer 700 (such as embodied within a storage area network (SAN)).

As is known in the art, the computer 700 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 708, loaded into the memory 706, and executed by the processor 702.

### Alternative Embodiments

The features and advantages described in the specification are not all inclusive and in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

It is to be understood that the figures and descriptions have been simplified to illustrate elements that are relevant for a clear understanding of the present invention, while eliminating, for the purpose of clarity, many other elements found in a typical online system. Those of ordinary skill in the art may recognize that other elements and/or steps are desirable and/or required in implementing the embodiments. However, because such elements and steps are well known in the art, and because they do not facilitate a better understanding of the embodiments, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the various embodiments. This description should be read to include one or at least one and the singular also includes the plural unless it is obvious that it is meant otherwise.

Upon reading this disclosure, those of skill in the art will appreciate still additional alternative structural and functional designs for a system and a process for displaying charts using a distortion region through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

We claim:

1. A computer implemented method for ranking search results, the method comprising:
for each of a plurality of search queries:
receiving, by an online system, the search query from a client device;
sending a plurality of search results matching the search query for presentation via a user interface of the client device;
receiving from the client device, information identifying one or more search results, each of the one or more search results identified responsive to an implicit user interaction with the search result, the implicit user interaction determined based on an amount of time a cursor is determined to exist within an area of the user interface displaying the search result; and
storing information associating the one or more identified search results with the search query;
for each of a plurality of entity types, determining an entity type relevance score based on past implicit user interactions with search results of the entity type;
ranking search results for subsequent search queries based on the entity type relevance score and returning the search results for display based on the rankings.

2. The method of claim 1, further comprising:
clustering the search queries into a plurality of clusters, each cluster comprising a set of similar search queries;
wherein any search query of a first cluster is representative of the other search queries of the cluster;
wherein the entity type relevance score is determined for each entity type for each cluster.

3. The method of claim 2, wherein determining the plurality of sets of similar search queries comprises grouping search queries based on similarity of search terms of the search queries.

4. The method of claim 2, wherein determining the plurality of sets of similar search queries comprises clustering similar search queries that have matching sets of search results.

5. The method of claim 2, wherein ranking search results for subsequent search queries based on the entity type relevance score and returning the search results for display based on the ranked order comprises:
receiving a new search query;
determining search results for the new search query, each search result having an entity type;
classifying the new search query to determine a matching set of similar search queries;
determining entity type relevance scores corresponding to the entity types for the identified set of similar search queries;
ranking the search results for the new search query based on entity type relevance scores corresponding to the entity type of the search result; and
sending, to the client device, the ranked search results for display via the user interface.

6. The method of claim 1, wherein an entity type relevance score for an entity type is proportionate to an aggregate amount of time spent by the cursor within an area of the user interface displaying the result.

7. The method of claim 1, wherein an entity type relevance score for an entity type is based on a number of times a cursor was present for more than a threshold amount of time within an area of the user interface displaying the search result corresponding to the entity type.

8. The method of claim 1, further comprising:
for each of a plurality of search queries:
receiving from the client device, information identifying one or more search results, each of the one or more search results identified responsive to an explicit user interaction with the search result, the explicit user interaction comprising a request from the user for additional information describing the identified search result;
wherein determining an entity type relevance score for an entity type is further based on past explicit user interactions with search results of the entity type.

9. The method of claim 8, wherein the entity type relevance score for an entity type is determined as a weighted aggregate of explicit user interactions and implicit user interactions with search results of the entity type.

10. The method of claim 8, wherein explicit user interactions are weighted higher than implicit user interactions.

11. A non-transitory computer-readable storage medium storing computer program instructions executable by a processor to perform operations comprising:
for each of a plurality of search queries:
receiving, by an online system, the search query from a client device;
sending a plurality of search results matching the search query for presentation via a user interface of the client device;
receiving from the client device, information identifying one or more search results, each of the one or more search results identified responsive to an implicit user interaction with the search result, the implicit user interaction determined based on an amount of time a cursor is determined to exist within an area of the user interface displaying the search result; and
storing information associating the one or more identified search results with the search query;
for each of a plurality of entity types, determining an entity type relevance score based on past implicit user interactions with search results of the entity type;
ranking search results for subsequent search queries based on the entity type relevance score and returning the search results for display based on the rankings.

12. The non-transitory computer-readable storage medium of claim 11, the operations further comprising:
clustering the search queries into a plurality of clusters, each cluster comprising a set of similar search queries;
wherein any search query of a first cluster is representative of the other search queries of the cluster;
wherein the entity type relevance score is determined for each entity type for each cluster.

13. The non-transitory computer-readable storage medium of claim 12, wherein determining the plurality of sets of similar search queries comprises grouping search queries based on similarity of search terms of the search queries.

14. The non-transitory computer-readable storage medium of claim 12, wherein determining the plurality of sets of similar search queries comprises grouping search queries in a set of similar search queries responsive to the search queries matching similar sets of search results.

15. The non-transitory computer-readable storage medium of claim 12, wherein ranking search results for subsequent search queries based on the entity type relevance score and returning the search results for display based on the ranked order comprises:
receiving a new search query;
determining search results for the new search query, each search result having an entity type;
classifying the new search query to determine a matching set of similar search queries;
determining entity type relevance scores corresponding to the entity types for the identified set of similar search queries;
ranking the search results for the new search query based on entity type relevance scores corresponding to the entity type of the search result; and
sending, to the client device, the ranked search results for display via the user interface.

16. The non-transitory computer-readable storage medium of claim 11, wherein an entity type relevance score for an entity type is proportionate to an aggregate amount of time spent by the cursor within an area of the user interface displaying the result.

17. The non-transitory computer-readable storage medium of claim 11, wherein an entity type relevance score for an entity type is based on a number of times an entity of the entity type was returned as a search result and a cursor was present for more than a threshold amount of time within an area of the user interface displaying the search result corresponding to the entity type.

18. The non-transitory computer-readable storage medium of claim 11, the operations further comprising:
for each of a plurality of search queries:
receiving from the client device, information identifying one or more search results, each of the one or more search results identified responsive to an explicit user interaction with the search result, the explicit user interaction comprising a request from the user for additional information describing the identified search result;
wherein determining an entity type relevance score for an entity type is further based on past explicit user interactions with search results of the entity type.

19. The non-transitory computer-readable storage medium of claim 18, wherein the entity type relevance score for an entity type is determined as a weighted aggregate of explicit user interactions and implicit user interactions with search results of the entity type.

20. The non-transitory computer-readable storage medium of claim 18, wherein explicit user interactions are weighted higher than implicit user interactions.
